(19) United States
(12) Patent Application Publication
(10) Pub. No.: US 2019/0221060 A1
(43) Pub. Date: Jul. 18, 2019

(54) SMART LOGISTIC LOCKER MANAGEMENT METHOD

(71) Applicant: Goldtek Technology Co., Ltd., New Taipei City (TW)

(72) Inventors: Chih-Hung Liu, New Taipei (TW); Shih-Wei Tseng, New Taipei (TW); Yen-Ching Lee, New Taipei (TW); Darwin Kurniawan Oh, New Taipei (TW); Po-Sheng Wang, New Taipei (TW); Yu-Chang Song, New Taipei (TW)

(21) Appl. No.: 15/913,862

(22) Filed: Mar. 6, 2018

(30) Foreign Application Priority Data
Jan. 15, 2018 (TW) 107101455

(51) Int. Cl. G07C 9/00

(52) U.S. Cl. CPC G07C 9/00158; G06K 9/00006; G07C 9/00912; G07C 9/00563

(57) ABSTRACT

A smart logistic locker comprises a plurality of compartments and a control station. The control station comprises a processor, a memory, a first sensing module, a second sensing module, an input/out interface, a communication module and a maintenance door. A smart logistic locker management method comprises below steps. The first sensing module obtains a first biological feature. The processor determines whether the first biological feature is authenticated. If the first biological feature is authenticated, the second sensing module obtains a second biological feature. The processor determines whether the second biological feature is authenticated. If the second biological feature is authenticated, the processor opens the maintenance door.

### CROSS-REFERENCE TO RELATED APPLICATIONS

This application claims priority to Taiwanese Invention Patent Application No. 107101455 filed on Jan. 15, 2018, the contents of which are incorporated by reference herein.

### FIELD

The present disclosure generally relates to a smart logistic locker management method. More particularly, the present disclosure relates to a smart logistic locker management method using two biological features for authentication.

### BACKGROUND

Currently, E-commence allows people to buy or sell items online instead of going to a store. The development of E-commence requires convenient delivery services. Recently, smart logistic lockers (also known as smart parcel lockers or automated parcel lockers) provides a new way of delivery service. People can send or receive items through the smart logistic lockers without handing the items to a logistic personnel. The smart logistic lockers are usually located at a public place that is convenient for people to reach or at a stop of people's daily communication, such as a grocery store or a metro station.

The maintenance process of the smart logistic locker is performed by a maintenance personnel. Before the maintenance process, the maintenance personnel uses a specific key to open a maintenance door of the smart logistic locker. Then, the maintenance personnel can carry out maintenance process, such as repairment or taking out cash from the smart logistic locker. However, as the number of the smart logistic locker is increasing, it is inconvenient to maintain the smart logistic lockers by the way of using a specific key to each smart logistic locker.

Therefore, there is a need to provide a more efficient way to manage the smart logistic locker.

### BRIEF DESCRIPTION OF THE DRAWINGS

Implementations of the present technology will now be described, by way of example only, with reference to the attached figures.

FIG. 1 a schematic diagram of a smart logistic locker according to an embodiment of the present disclosure.

FIG. 2 is a block diagram of the smart logistic locker according to an embodiment of the present disclosure.

FIG. 3 is a flowchart of a smart logistic locker management method according to a first embodiment of the present disclosure.

FIG. 4 is a schematic diagram of the smart logistic locker management method according to a second embodiment of the present disclosure.

FIG. 5 is a flowchart of the smart logistic locker management method according to the second embodiment of the present disclosure.

### DETAILED DESCRIPTION

The present disclosure will now be described more fully hereinafter with reference to the accompanying drawings, in which embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

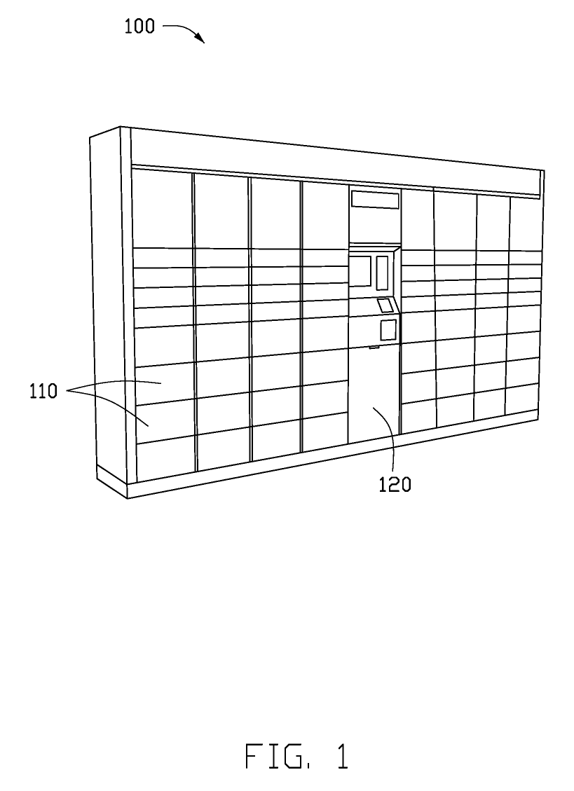

The description will be made as to the embodiments of the present disclosure in conjunction with the accompanying drawings in FIGS. 1 to 5. Reference will be made to the drawing figures to describe the present disclosure in detail, wherein depicted elements are not necessarily shown to scale and wherein like or similar elements are designated by same or similar reference numeral through the several views and same or similar terminology.

The present disclosure will be further described hereafter in combination with figures.

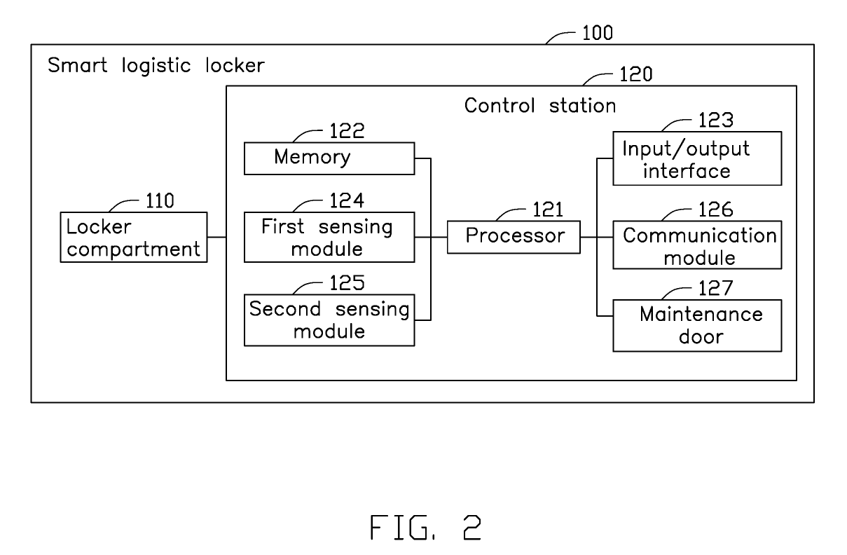

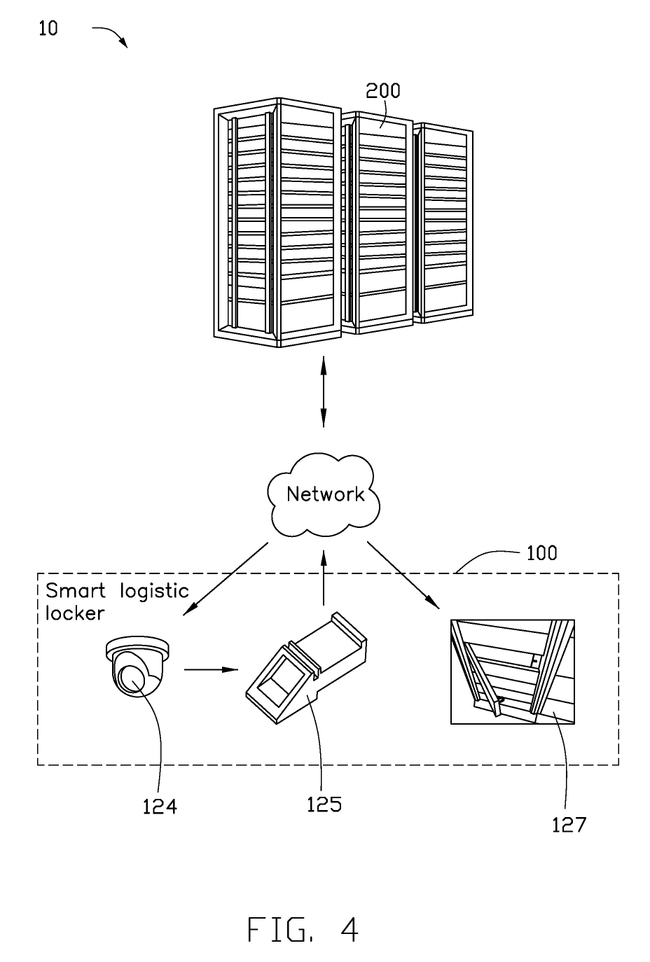

Referring to FIGS. 1 and 2, FIG. 1 a schematic diagram of a smart logistic locker according to an embodiment of the present disclosure; FIG. 2 is a block diagram of the smart logistic locker according to an embodiment of the present disclosure. As shown in FIG. 2, the smart logistic locker 100 is for sending and receiving items. The smart logistic locker 100 is sometimes also known as a smart parcel locker or an automated parcel locker, but not limited thereto. The smart logistic locker 100 of the present disclosure comprises a plurality of locker compartments 110 and a control station 120. The locker compartment is for placing the items. The control station 120 controls an opening and a closing of the plurality of the locker compartments 110. The control station 120 comprises a first sensing module 124, a second sensing module 125, a maintenance door 127, and a processor 121. The first sensing module 124 obtains a first biological feature. The second sensing module 125 obtains a second biological feature. The first biological feature is a human face image, a fingerprint, a voice, a vein image or an iris image. The second biological feature is a human face image, a fingerprint, a voice, a vein image or an iris image. The first biological feature and the second biological feature can be other biological features that can be used as an identification of individuals, not limited to the above mentioned biological features. Preferably, the first biological feature is a human face image; and the second biological feature is a fingerprint. The maintenance door 127 is for maintaining the smart logistic locker 100. The processor 121 connects to and controls the first sensing module 124, the second sensing module 125, and the maintenance door 127. If the first biological feature and the second biological feature are authenticated, the processor 121 opens the maintenance door 127. The control station 120 further comprises a memory 122, an input/output interface 123, and a communication module 126. The memory 122 stores information. The input/output interface 123 can be a touch panel. Users can use the input/output interface 123 to input information of sending or receiving items. The communication module 126 transmit the first biological feature and the second biological feature to a server (such as the server 200 shown in FIG. 4). The communication module 126 can a wired network module or a wireless internet module (such as a 4G LTE modem). When the user needs to send an item, the user can logon to a website provided by a logistic service provider to fill in delivery information. The user receives a delivery code from the website. Then, the user takes the item to the smart logistic locker 100 and inputs the delivery code to the control station 120 by the input/output interface 123. After payment, the user places the item in the corresponding locker compartment 110 to finish the sending process. When the user needs to receive an item, the user can input a receiving code to the control station 110 by the input/output interface 123. The corresponding locker compartment 110 is opened to allow the user to take out the item. The sending process and the receiving process are conventional processes of a smart logistic locker without further description.

However, what is not conventional is that when a maintenance personnel needs to carry out a maintenance process to the smart logistic locker 100 (such as repairment, regular check, or taking out cash in the control station 120), the first sensing module 124 and the second sensing module 125 respectively obtain the first biological feature and the second biological feature of the maintenance personnel. If the first biological feature and the second feature of the maintenance personnel are authenticated, the processor 121 opens the maintenance door 127 to allow the maintenance personnel to carry out the maintenance process to the smart logistic locker 100.

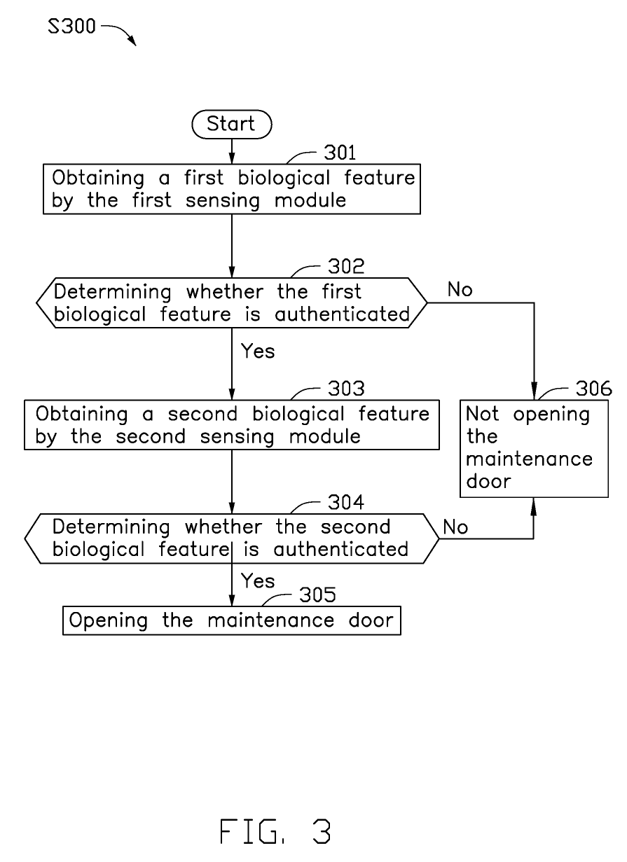

Referring to FIG. 3, FIG. 3 is a flowchart of a smart logistic locker management method according to a first embodiment of the present disclosure. The smart logistic locker management method S300 of the first embodiment of the present disclosure is performed by a smart logistic locker. The smart logistic locker can be referred to the smart logistic locker 100 as shown in FIG. 2. The smart logistic locker 100 shown in FIG. 2 comprises a plurality of locker compartments 110 and a control station 120. The control station 120 comprises a processor 121, a memory 122, a first sensing module 124, a second sensing module 125, an input/output interface 123, a communication module 126, and a maintenance door 127. As shown in FIG. 3, the smart logistic locker management method S300 comprises steps of S301 to S306. In step S301, the first sensing module 124 obtains a first biological feature. The first biological feature may be a human face image, a fingerprint, a voice, a vein image or an iris image. In the first embodiment, the first biological feature is a human face image; and the first sensing module 124 is a conventional camera, an IR-LED camera, an IR camera, or a depth sensor. In step S302, the processor 121 determines whether the first biological feature is authenticated. Specifically, the processor 121 compares the first biological feature to a first authenticated biological feature that is pre-stored in the memory 122. The processor 121 determines whether the first biological feature matches the first authenticated biological feature. For example, the processor 121 compares a human face image obtained by the first sensing module 124 to a human face image of an authenticated maintenance personnel that is pre-stored in the memory 122 to determine whether the human face image obtained by the first sensing module 124 is authenticated. If the determination in step S302 is YES, the smart logistic locker management method S300 proceeds step S303. If the determination in step S302 is NO, the smart logistic locker management method S300 proceeds step S306. In step S303, if the first biological feature is authenticated, the second sensing module 125 obtains a second biological feature. The second biological feature may be a human face image, a fingerprint, a voice, a vein image or an iris image. In the first embodiment, the second biological feature is a fingerprint; and the second sensing module 125 is a fingerprint sensor. In step S304, the processor 121 determines whether the second biological feature is authenticated. Specifically, the processor 121 compares the second biological feature to a second authenticated biological feature that is pre-stored in the memory 122. The processor 121 determines whether the second biological feature matches the second authenticated biological feature. For example, the processor 121 compares a fingerprint obtained by the second sensing module 125 to a fingerprint of an authenticated maintenance personnel that is pre-stored in the memory 122 to determine whether the fingerprint obtained by the second sensing module 125 is authenticated. If the determination in step S304 is YES, the smart logistic locker management method S300 proceeds step S305. If the determination in step S304 is NO, the smart logistic locker management method S300 proceeds step S306. In step S305, if the second biological feature is authenticated, the processor 121 opens the maintenance door 127. In step S306, if the first biological feature or the second biological feature is not authenticated, the smart logistic locker 100 does not open the maintenance door 127.

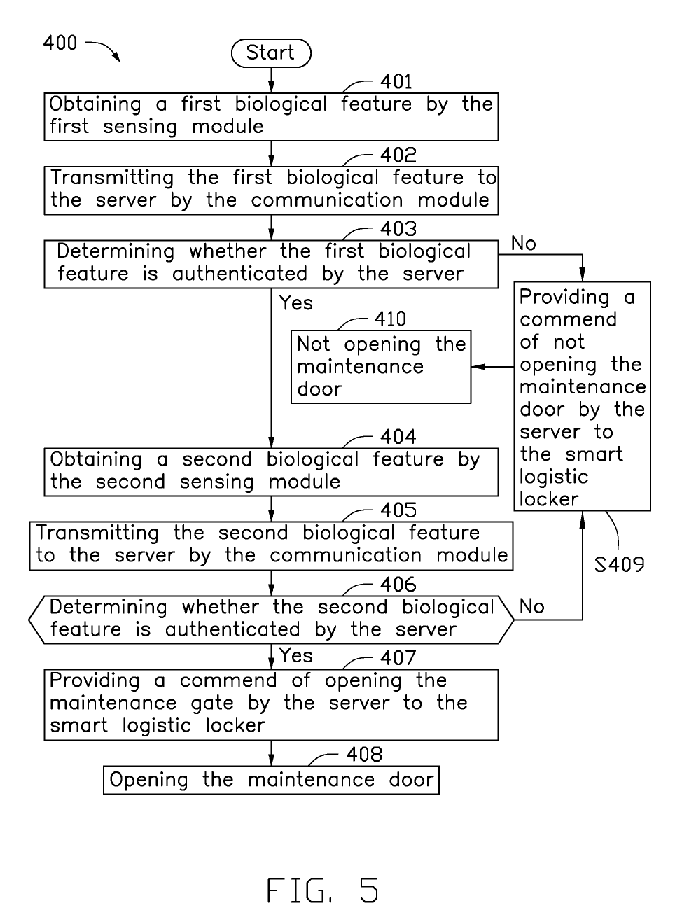

Referring to FIGS. 4 and 5, FIG. 4 is a schematic diagram of the smart logistic locker management method according to a second embodiment of the present disclosure; and FIG. 5 is a flowchart of the smart logistic locker management method according to the second embodiment of the present disclosure. The smart logistic locker management method S400 of the second embodiment is performed by a smart logistic locker system 10. The smart logistic locker system 10 comprises at least one smart logistic locker 100 and a server 200. The smart logistic locker 100 can be referred to the smart logistic locker 100 as shown in FIG. 2. The smart logistic locker 100 comprises a plurality of locker compartments 110 and a control station 120. The control station 120 comprises a processor 121, a memory 122, a first sensing module 124, a second sensing module 125, an input/output interface 123, a communication module 126, and a maintenance door 127. The smart logistic locker management method S400 comprises steps of S401 to S410. In step S401, the first sensing module 124 obtains a first biological feature. The first biological feature may be a human face image, a fingerprint, a voice, a vein image or an iris image. In the second embodiment, the first biological feature is a human face image; and the first sensing module 124 is a conventional camera, an IR-LED camera, an IR camera or a depth sensor. In step S402, the communication module 126 of the smart logistic locker 100 transmits the first biological feature to the server 200. In step S403, the server 200 determines whether the first biological feature is authenticated. Specifically, the server 200 compares the first biological feature to a first authenticated biological feature that is pre-stored in the server 200. The server 200 determines whether the first biological feature matches the first authenticated biological feature. For example, the server 200 compares a human face image obtained by the first sensing module 124 to a human face image of an authenticated maintenance personnel that is pre-stored in the server 200 to determine whether the human face image obtained by the first sensing module 124 is authenticated. If the determination in step S403 is YES, the smart logistic locker management method S400 proceeds step S404. If the determination in step S403 is NO, the smart logistic locker management method S400 proceeds step S409. In step S404, if the first biological feature is authenticated, the second sensing module 125 obtains a second biological feature. The second biological feature may be a human face image, a fingerprint, a voice, a vein image or an iris image. In the second embodiment, the second biological feature is a fingerprint; and the second sensing module is a fingerprint sensor. In step S405, the communication module 126 transmits the second biological feature to the server 200. In step S406, the server 200 determines whether second biological feature is authenticated. Specifically, the server 200 compares the second biological feature to a second authenticated biological feature that is pre-stored in the server 200. The server 200 determines whether the second biological feature matches the second authenticated biological feature. For example, the server compares a fingerprint obtained by the second sensing module 125 to a fingerprint of an authenticated maintenance personnel that is pre-stored in the server to determine whether the fingerprint obtained by the second sensing module 125 is authenticated. If the determination in step S406 is YES, the smart logistic locker management method S400 proceeds step S407. If the determination in step S406 is NO, the smart logistic locker management method S400 proceeds step S409. In step S407, if the second biological feature is authenticated, the server 200 provides a command of opening the maintenance door 127 to the smart logistic locker 100. In step S408, the processor 121 of the smart logistic locker 100 opens the maintenance door 127. In step S409, if the first biological feature or the second biological feature is not authenticated, the server 200 provides a command of not opening the maintenance door 127 to the smart logistic locker 100. In step S410, the smart logistic locker 100 does not open the maintenance door 127.

As described above, the smart logistic locker management method of the present disclosure uses two sensing modules to obtain biological features of a maintenance personnel. The biological features are transmitted to a server to determine whether the biological features are authenticated. Accordingly, the opening and the closing of the maintenance door of the smart logistic locker are controlled. Therefore, compared to a convention method of using keys to open the maintenance door of the smart logistic locker, the smart logistic locker management method of the present disclosure can effectively maintain the smart logistic locker in a simpler way.

The embodiments shown and described above are only examples. Many details are often found in the art such as the other features of a smart logistic locker management method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A smart logistic locker management method for a smart logistic locker; wherein the smart logistic locker comprises a plurality of locker compartments and a control station; the control station comprises a processor, a memory, a first sensing module, a second sensing module, an input/output interface, a communication module, and a maintenance door; and the smart logistic locker management method comprises:
obtaining a first biological feature by the first sensing module;
determining whether the first biological feature is authenticated;
obtaining a second biological feature by the second sensing module;
determining whether the second biological feature is authenticated; and
if the first and second biological features are authenticated, opening the maintenance door.

2. The smart logistic locker management method of claim 1, further comprising:
if the first biological feature is not authenticated, not opening the maintenance door.

3. The smart logistic locker management method of claim 1, further comprising:
if the second biological feature is not authenticated, not opening the maintenance door.

4. The smart logistic locker management method of claim 1, wherein the first biological feature is a human face image, a fingerprint, a voice, a vein image or an iris image.

5. The smart logistic locker management method of claim 1, wherein the second biological feature is a human face image, a fingerprint, a voice, a vein image or an iris image.

6. A smart logistic locker management method for a smart logistic locker system; wherein the smart logistic locker system comprises at least one smart logistic locker and a server; the smart logistic locker comprises a plurality of locker compartments and a control station; the control station comprises a processor, a memory, a first sensing module, a second sensing module, an input/output interface, a communication module, and a maintenance door; and the smart logistic locker management method comprises:
obtaining a first biological feature by the first sensing module;
transmitting the first biological feature to the server by the communication module;
determining whether the first biological feature is authenticated by the server;
obtaining a second biological feature by the second sensing module;
transmitting the second biological feature to the server by the communication module;
determining whether the second biological feature is authenticated by the server;
if the first and second biological features are authenticated, providing a command of opening the maintenance door by the server to the smart logistic locker; and
opening the maintenance door.

7. The smart logistic locker management method of claim 6, further comprising:
if the first biological feature is not authenticated, providing a command of not opening the maintenance door by the server to the smart logistic locker; and
not opening the maintenance door.

8. The smart logistic locker management method of claim 6, further comprising:
if the second biological feature is not authenticated, providing a comment of not opening the maintenance door by the server to the smart logistic locker; and
not opening the maintenance door.

9. A smart logistic locker for sending and receiving items, comprising:
a plurality of locker compartments for placing the items; and
a control station for controlling an opening and a closing of the locker compartment;
wherein the control station comprises:
a first sensing module for obtaining a first biological feature;
a second sensing module for obtaining a second biological feature:
a maintenance door for maintaining the smart logistic locker; and
a processor connecting to and controlling the first sensing module, the second sensing module, and the maintenance door;
wherein if the first biological feature and the second biological feature are authenticated, the processor opens the maintenance door.

10. The smart logistic locker of claim 9, wherein the control station further comprises a communication module; and the communication module transmits the first biological feature and the second biological feature to a server.
